(19) United States
(12) Patent Application Publication
(10) Pub. No.: US 2006/0245192 A1
(43) Pub. Date: Nov. 2, 2006

(54) Satellite lighting assembly

(76) Inventor: Frank Polidoro, Cumberland, RI (US)

Correspondence Address: IP STRATEGIES, 12 1/2 WALL STREET, SUITE I, ASHEVILLE, NC, 28801, US

(21) Appl. No.: 11/119,299

(22) Filed: Apr. 28, 2005

(51) Int. Cl. F21V 33/00

(52) U.S. Cl. 362/253

(57) ABSTRACT

A lighting assembly includes a main lighting unit and a remote lighting unit. The main lighting unit includes a stimulus detector and a transmitter. The remote lighting unit includes a receiver unit and a remote light socket. The main lighting unit responds to detection of a predetermined stimulus by the stimulus detector to cause the transmitter to transmit an actuation signal. The receiver unit receives the actuation signal and in response changes an actuation state of the remote light socket from a first actuation state to a second actuation state.

### FIELD OF THE INVENTION

The present invention relates to lighting systems having more than one light element, suitable, for example, for lighting an area such as a corridor, an entryway, or a flight of stairs. The present invention also relates to lighting systems that are actuated in reaction to an expected activity or natural stimulus, rather than to a dedicated action to actuate the system, such as by operating a switch.

### BACKGROUND OF THE INVENTION

Many environments exist in which illumination is required during times that are inconvenient to manually operate a switch to actuate a lighting system. Lighting systems have been devised for such environments that are actuated by responding to a more convenient action, such as clapping the hands, or to a natural stimulus, such as motion in the vicinity of the lighting system. It would be advantageous to provide a lighting system that is actuated in response to a predetermined stimulus, and that includes satellite lighting elements that define a path or area in an otherwise darkened environment.

### BRIEF SUMMARY OF THE INVENTION

The present invention is a lighting assembly that includes a main lighting unit and at least one remote lighting unit. The main lighting unit includes a stimulus detector and a transmitter. The remote lighting unit includes a receiver unit and a remote light socket. The main lighting unit responds to detection of a predetermined stimulus by the stimulus detector to cause the transmitter to transmit an actuation signal. The receiver unit receives the actuation signal and in response changes an actuation state of the remote light socket from a first actuation state to a second actuation state. For example, the receiver unit can include a receiver that receives the actuation signal and a controller that changes the actuation state of the remote light socket in response to receipt of the actuation signal.

According to an embodiment of the present invention, the remote lighting unit can include a light element in communication with the remote light socket such that the light element is illuminated when the actuation state of the remote light socket is changed from the first actuation state to the second actuation state. For example, the light element can be a light bulb or an LED. Alternatively, the remote lighting unit can include a light element in communication with the remote light socket such that the light element is illuminated at a first brightness level when the remote light socket is in the first actuation state, and the light element is illuminated at a second brightness level when the remote light socket is in the second actuation state. For example, the second brightness level can be greater than the first brightness level. As another alternative, the remote lighting unit can include a plurality of remote light sockets. The number of the plurality of the remote light sockets that is actuated can change from a first number of actuated remote light sockets to a second number of actuated remote light sockets in response to detection of the predetermined stimulus by the stimulus detector. For example, the second number of actuated remote light sockets can be greater than the first number of the plurality of actuated remote light sockets.

According to an embodiment of the present invention, the main lighting unit can also include a main light socket. In this embodiment, an actuation state of the main light socket can be changed from a first actuation state to a second actuation state in response to detection of the predetermined stimulus by the stimulus detector. The main lighting unit can also include a light element in communication with the main light socket such that the light element is illuminated when the actuation state of the main light socket is changed from a first actuation state to a second actuation state. For example, the light element can be a light bulb or an LED. Alternatively, the main lighting unit can include a light element in communication with the main light socket such that the light element is illuminated at a first brightness level when the main light socket is in the first actuation state, and the light element is illuminated at a second brightness level when the main light socket is in the second actuation state. For example, the second brightness level can be greater than the first brightness level. As another alternative, the main lighting unit can include a plurality of main light sockets. According to this embodiment, the number of main light sockets actuated can change from a first number to a second number in response to detection of the predetermined stimulus by the stimulus detector. For example, the second number of actuated main light sockets can be greater than the first number of the plurality of actuated main light sockets.

According to a particular aspect of the invention, the stimulus detector can be a motion detector, such as a heat-sensing motion detector, a light-sensing motion detector, or a pressure-sensing motion detector, such as a detector that senses a change in sound level.

According to another aspect of the invention, the transmitter can be an RF transmitter and the receiver unit can include an RF receiver. Alternatively, the main lighting unit and the remote lighting unit can include respective couplers that are adapted to couple the transmitter and the receiver unit for communication over an electrically-conductive path. For example, the respective couplers can be adapted to couple the transmitter and the receiver unit for communication over AC house wiring. Alternatively, the respective couplers can be adapted to couple the transmitter and the receiver unit for communication over a cable. For example, the respective couplers can be adapted to couple the transmitter and the receiver unit for communication over fiber-optic cable. In any case, the transmitter can be adapted to transmit the actuation signal over the electrically-conductive path, and the receiver unit can be adapted to receive the actuation signal over the electrically-conductive path.

The lighting assembly can also include a timer that initiates a count when the stimulus detector detects the predetermined stimulus, or when the receiver unit receives the actuation signal. In such an embodiment, the lighting assembly can also include a controller that returns the actuation state of the remote light socket from the second actuation state to the first actuation state when the count reaches a predetermined value.

The lighting assembly can include multiple remote lighting units, each of which can receive actuation signals from the main lighting unit, or which can pass actuation signals along in series between remote lighting units. For example, the lighting assembly can include a second remote lighting unit that includes a second receiver unit and a second remote light socket. In this case, the second receiver unit can receive the actuation signal from the main lighting unit and in response can change an actuation state of the second remote light socket from a first actuation state to a second actuation state. Alternatively, the first remote lighting unit can include a second transmitter that transmits a second actuation signal in response to receipt of the first actuation signal by the first receiver unit. In this case, the second receiver unit can receive the second actuation signal and in response can change an actuation state of the second remote light socket from a first actuation state to a second actuation state.

### BRIEF DESCRIPTION OF THE DRAWINGS

FIG. 1 is a block diagram of an exemplary embodiment of the lighting assembly of the present invention.

FIG. 2 is a block diagram of an exemplary embodiment of a remote lighting unit of the present invention.

FIG. 3 is a block diagram of an exemplary embodiment of a main lighting unit of the present invention.

FIG. 4 is a block diagram of an exemplary embodiment of a main lighting unit of the present invention.

FIG. 5 is a block diagram of an exemplary embodiment of the lighting assembly of the present invention.

FIG. 6 is a block diagram of an exemplary embodiment of the lighting assembly of the present invention.

FIG. 7 is a block diagram of an exemplary embodiment of the lighting assembly of the present invention.

FIG. 8 is a block diagram of an exemplary embodiment of the lighting assembly of the present invention.

FIG. 9 is a block diagram of an exemplary embodiment of the lighting assembly of the present invention.

FIG. 10 is a block diagram of an exemplary main lighting unit of the system of the present invention.

FIG. 11 is a block diagram of an exemplary remote lighting unit of the system of the present invention.

FIG. 12 is a schematic diagram of exemplary main lighting unit circuitry for use in the system of the present invention.

FIG. 13 is a schematic diagram of exemplary main lighting unit circuitry for use in the system of the present invention.

FIG. 14 is a schematic diagram of exemplary remote lighting circuitry for use in the system of the present invention.

### DETAILED DESCRIPTION OF THE INVENTION

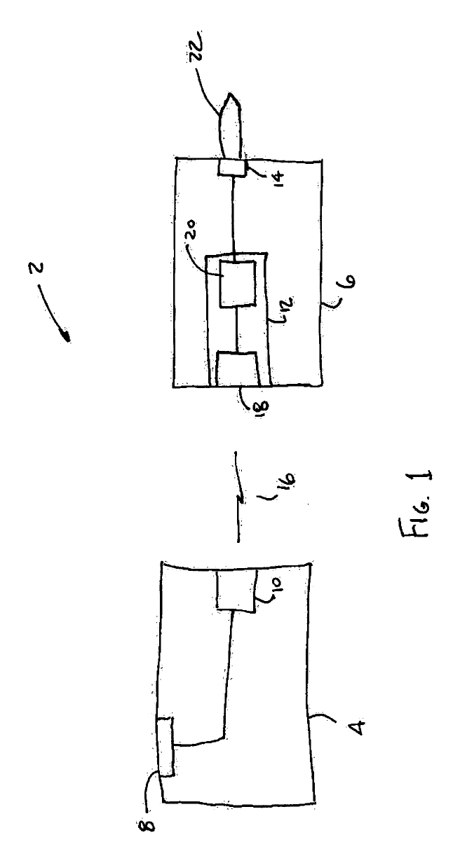

As shown in FIG. 1, the lighting assembly 2 of the present invention includes a main lighting unit 4 and at least one remote lighting unit 6. The main lighting unit 4 includes a stimulus detector 8 and a transmitter 10. Each remote lighting unit 6 includes a receiver unit 12 and a light socket 14. For example, according to an embodiment of the present invention, the transmitter 10 is an RF transmitter and the receiver unit 12 includes an RF receiver. The stimulus detector 8 is adapted to detect a predetermined stimulus.

The stimulus detector 8 preferably responds to a stimulus that is a natural action of a person benefiting from the illumination. For example, the stimulus detector 8 can be a motion detector, such as a heat-sensing motion detector, a light-sensing motion detector, or a pressure-sensing motion detector. According to other embodiments of the present invention, a pressure-sensing detector senses a change in sound level, and a particular sound, such as a hand clap, is detected by the stimulus detector 8.

On detection of the stimulus, the transmitter 10 transmits an actuation signal 16. When the receiver unit 12 receives the actuation signal 16, the remote lighting unit 6 changes an actuation state of the light socket 14. In an exemplary embodiment of the lighting assembly 2 shown in FIG. 1, the receiver unit 12 includes a receiver 18 that receives the actuation signal 16 and a controller 20 that changes the actuation state of the light socket 14 in response to receipt of the actuation signal 16.

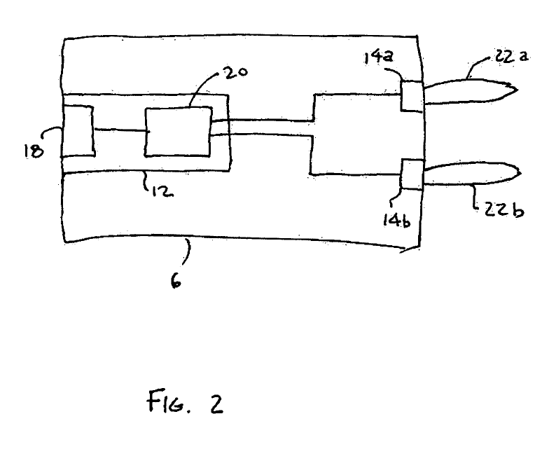

As shown in FIG. 1, this embodiment of the remote lighting unit 6 includes a light element 22 in communication with the light socket 14. According to the exemplary embodiment shown, the light element 22 is a light bulb, but this element could be an LED or any other illuminating device. A change in the actuation state of the light socket 14 has an effect on the illumination of the light element 22. For example, the light element 22 can be illuminated when the actuation state of the light socket 14 is changed. Alternatively, illumination of the light element 22 can change brightness levels with a change in the actuation state of the light socket 14. For example, the light element 22 can change from a dim glow to bright illumination on detection of the stimulus, through use of a conventional multiple-level socket and/or lighting element. As another alternative, the remote lighting unit 6 can include more than one light socket 14a, 14b and corresponding lighting elements 22a, 22b, as shown in the embodiment of FIG. 2. According to this embodiment, the number of light sockets actuated, and therefore the number of lighting elements illuminated, changes on receipt by the receiver unit 12 of the actuation signal 16. For example, prior to receiving the actuation signal 16, the remote lighting unit 6 can cause one lighting element 22a to be illuminated, whereas both lighting elements 22a, 22b can be illuminated in response to detection of the stimulus. The number of actuated light sockets can be controlled by the controller 20, or by digital logic circuits, hard-wiring control, or any other known arrangement.

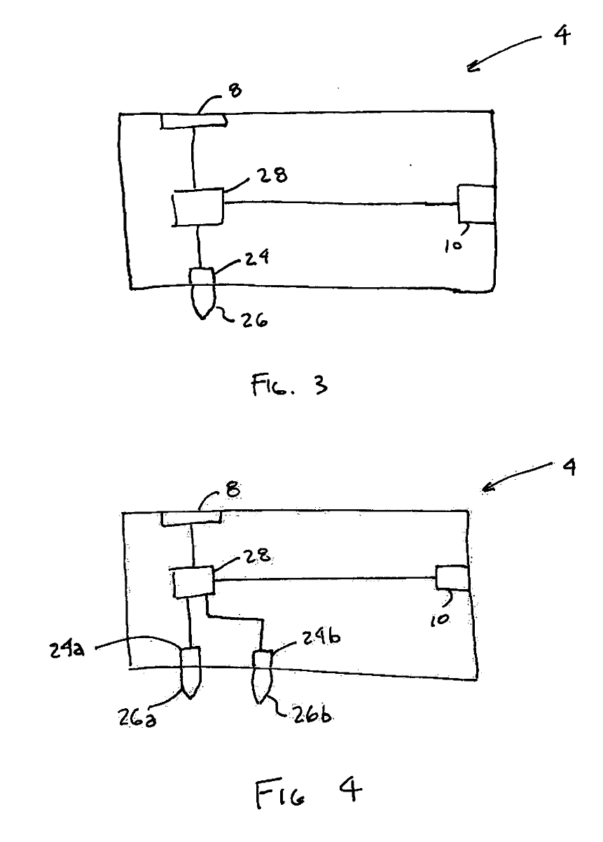

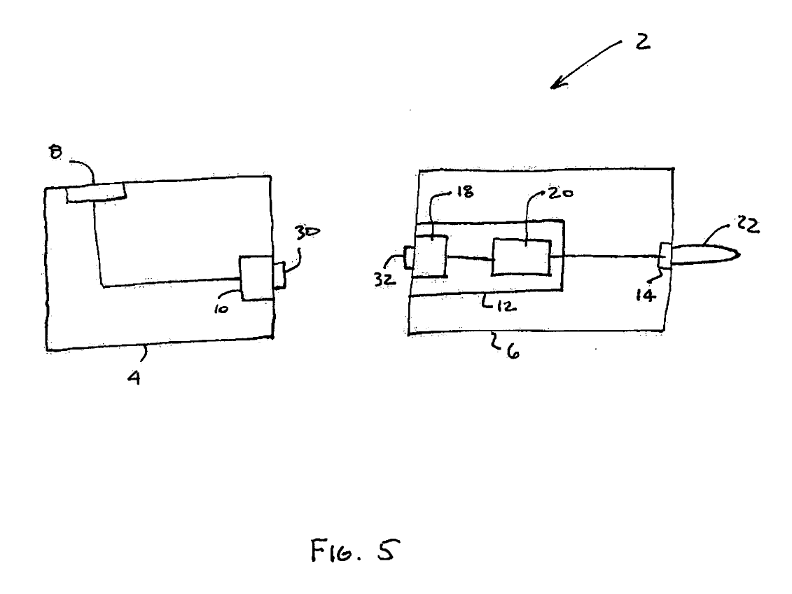

As shown in FIG. 3, according to an exemplary embodiment of the present invention, the main lighting unit 4 can also include a light socket 24. In this embodiment, an actuation state of the light socket 24 can be changed from a first actuation state to a second actuation state in response to detection of the predetermined stimulus by the stimulus detector 8. The main lighting unit 4 can also include a light element 26, such as a light bulb, in communication with the light socket 24. The light element 26 can be illuminated when the actuation state of the light socket 24 is changed. Alternatively, illumination of the light element 26 can change brightness levels with a change in the actuation state of the light socket 24. For example, the light element 26 can change from a dim glow to bright illumination on detection of the stimulus, through use of a conventional multiple-level socket and/or lighting element. As another alternative, the main lighting unit 4 can include more than one light socket 24a, 24b and corresponding lighting elements 26a, 26b, as shown in the embodiment of FIG. 4. According to this embodiment, the number of light sockets actuated, and therefore the number of lighting elements illuminated, changes on detection by the stimulus detector 8 of the predetermined stimulus. For example, prior to detecting the stimulus, the main lighting unit 4 can cause one lighting element 26a to be illuminated, whereas both lighting elements 26a, 26b can be illuminated in response to detection of the stimulus. The number of actuated light sockets can be controlled by a controller 28, or by digital logic circuits, hard-wiring control, or any other known arrangement.

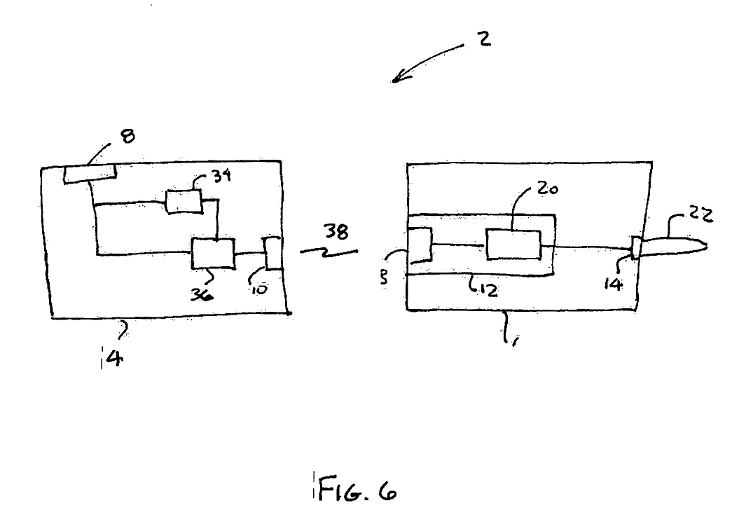

According to another embodiment of the present invention, as shown schematically in FIG. 5, the main lighting unit 4 and the remote lighting unit 6 include respective couplers 30, 32 that are adapted to couple the transmitter 10 and the receiver unit 12 for communication over an electrically-conductive path. For example, the transmitter 10 and the receiver unit 12 can include circuitry for allowing communication via AC house wiring, and the couplers 30, 32 can be common AC electrical plugs that are adapted to mate with conventional AC sockets. Alternatively, the respective couplers 30, 32 can be adapted to couple the transmitter and the receiver unit for communication over a cable linking the transmitter 10 and the receiver unit 12, such as a common metal-conductor cable or fiber-optic cable. In any case, according to this embodiment, the transmitter 10 is adapted to transmit the actuation signal 16 over the electrically-conductive path, and the receiver unit 12 is adapted to receive the actuation signal 16 over the electrically-conductive path. Thus, the couplers 30, 32 include any interface circuitry necessary to enable communication.

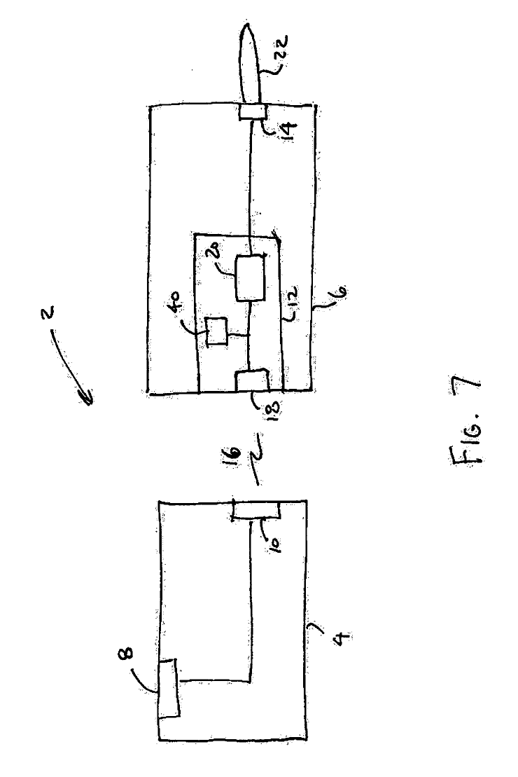

Referring to FIG. 6, another embodiment of the present invention includes a timer 34, which initiates a count when the stimulus detector 8 detects the predetermined stimulus. As shown, a controller 36 returns the actuation state of the remote light socket 18 from the second actuation state to the first actuation state when the count reaches a predetermined value. This can be effectuated by causing the transmitter 10 to send a de-actuation signal 38 when the count is reached by the timer 34. In an alternative embodiment, shown in FIG. 7, a timer 40 initiates a count when the receiver unit 12 receives the actuation signal. The controller 20 returns the actuation state of the remote light socket 18 from the second actuation state to the first actuation state when the count reaches a predetermined value, as long as the actuation signal 16 does not persist or recur.

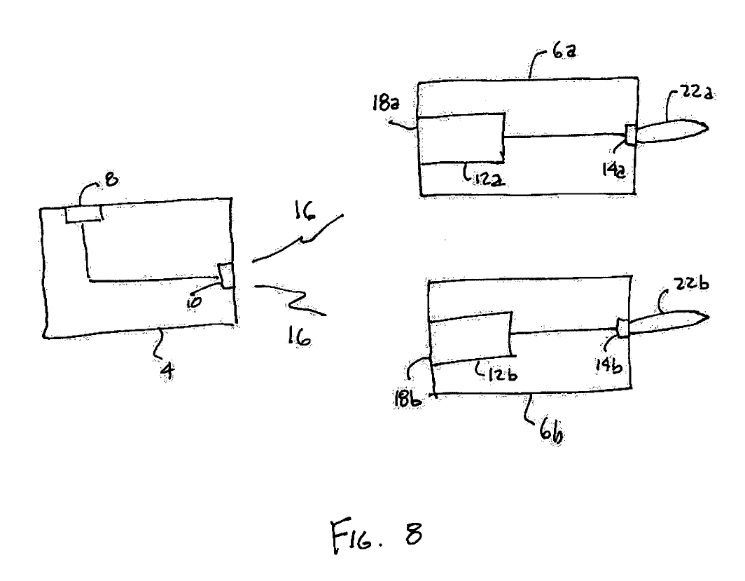

It is contemplated that the lighting assembly of the present invention can include more than one remote lighting unit. For example, as shown in FIG. 8, a particular embodiment includes a first remote lighting unit 6a including a first receiver unit 12a and a first remote light socket 14a, and a second remote lighting unit 6b including a second receiver unit 12b and a second remote light socket 14b. Both receiver units 6a, 6b receive the actuation signal 16 and in response change an actuation state of the respective remote light socket 14a, 14b from a first actuation state to a second actuation state.

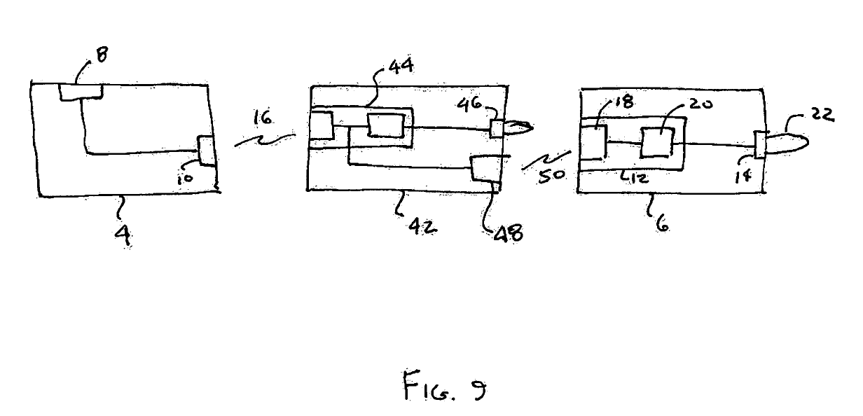

As an alternative to the parallel configuration shown in FIG. 8, multiple remote lighting units can also be functionally arranged in serial fashion, as shown in FIG. 9. In this embodiment, a second remote lighting unit 42 is functionally located between the main lighting unit 4 and the first remote lighting unit 6. In addition to the receiver unit 44 and the light socket 46, the second remote lighting unit 42 includes a transmitter 48 that transmits a second actuation signal 50 in response to receipt of the first actuation signal 16 by the receiver unit 44. The first remote lighting unit 6 receives the second actuation signal 50 and in response changes the actuation state of the remote light socket 14 from a first actuation state to a second actuation state.

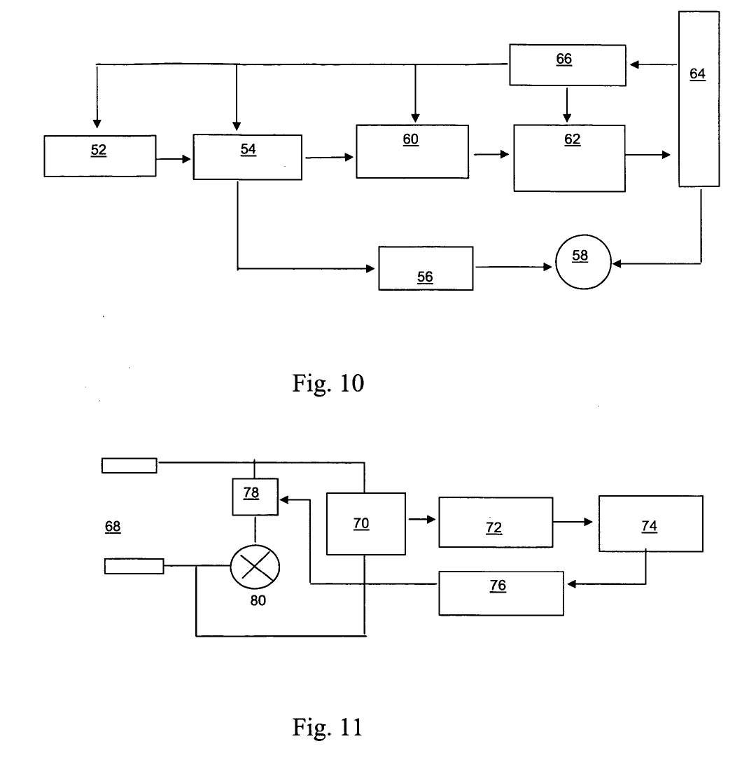

FIG. 10 is a block diagram of an exemplary main lighting unit of an exemplary system of the present invention. As shown, an infrared motion sensor 52 is used to detect motion in a region of interest for this particular embodiment. On detection of motion in the region, the sensor 52 provides a signal to a motion signal amplifier 54, which enables a triac 56 to actuate a lamp 58 for illumination. Preferably, the sensor signal or the amplifier signal is held for a predetermined period of time, for example, three minutes, so that the lamp will remain illuminated for a sufficient amount of time after a person has moved out of the detection region. Power for the lamp is provided by connection to an AC line 64.

On receiving the sensor signal, the motion signal amplifier 54 also actuates an oscillator 60, which provides an alternating signal to a suitable filter and amplifier 62, thereby providing a carrier signal for transmission over the AC line 64. The carrier signal is detected by the receiver of a remote lighting unit, which likewise illuminates a lamp. The AC line 64 also provides power to the motion sensor 52, motion signal amplifier 54, oscillator 60, and filter/amplifier 62. The AC signal is processed by a rectifier 66 prior to powering these devices.

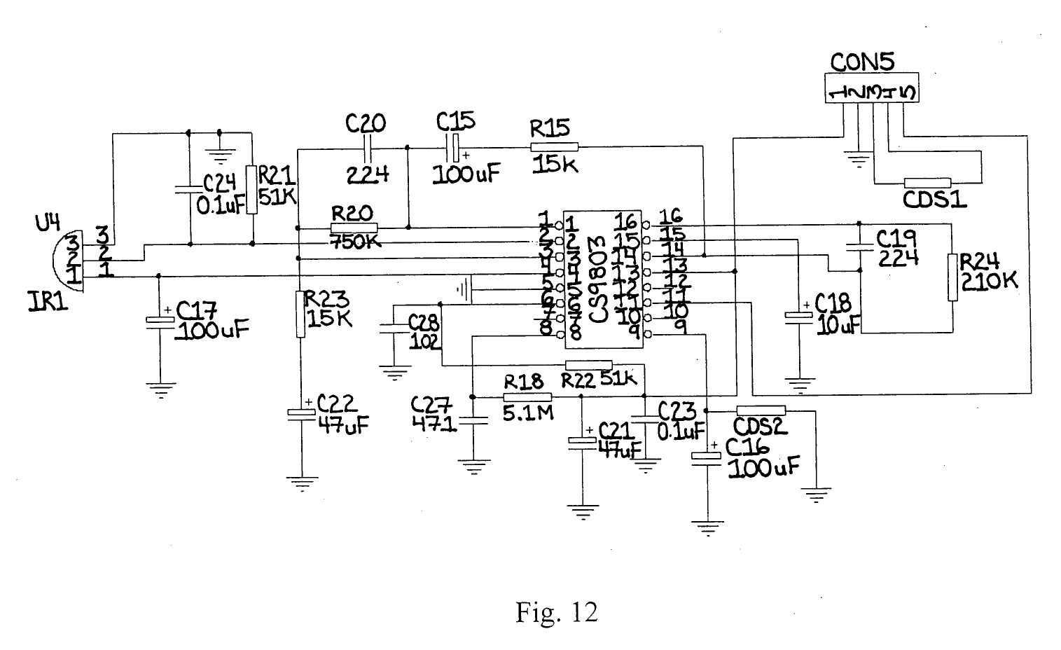

FIG. 11 is a block diagram showing an exemplary embodiment of a remote lighting unit according to the present invention. As shown, terminals across the AC line 68 receive AC power, and also receive the carrier signal transmitted by the main lighting unit. In the exemplary embodiment shown, the signal is received by a 150 KHz filter 70. The signal then undergoes amplification at an amplifier stage 72. The amplified signal is provided to a tone detector 74, which generates a positive logic signal to actuate an optical coupler 76 when the signal from the transmitter is detected. On actuation, the optical coupler 76 allows the triac 78 to provide power to illuminate the lamp 80. Thus, on receipt of the expected carrier signal from the main lighting unit, the lamp on the remote lighting unit is illuminated.

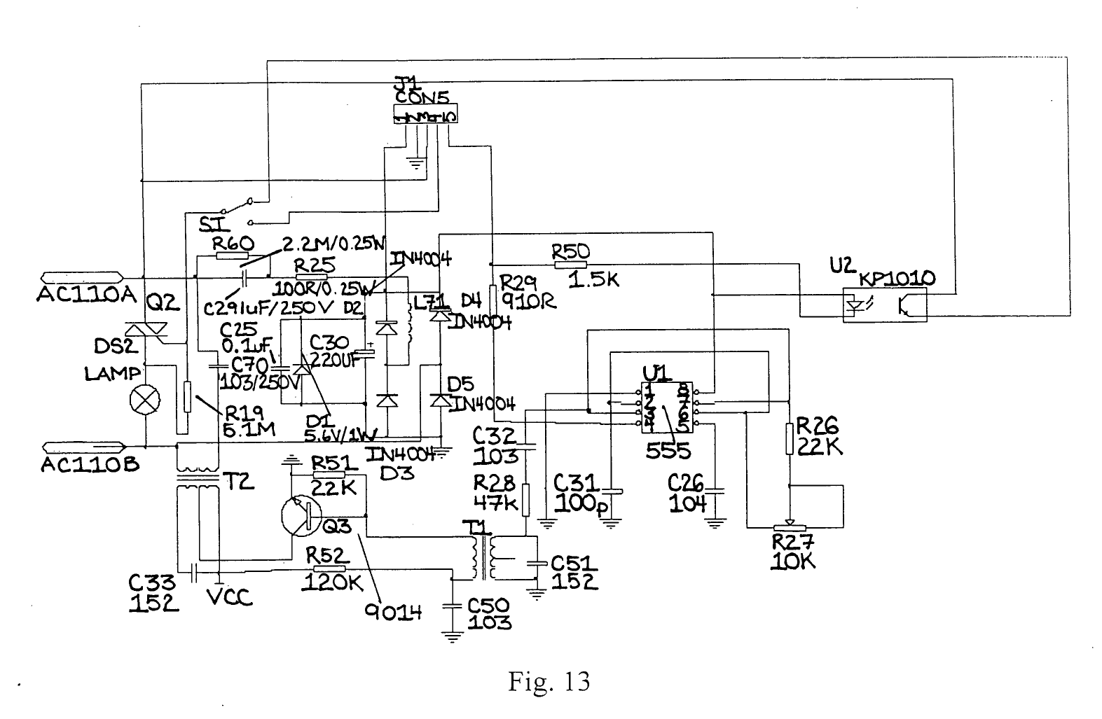

FIGS. 12 and 13 are schematic diagrams of exemplary circuits that provide the functionality of the main lighting unit. The circuits shown are connected via a connector J1. As shown in FIG. 12, in this particular embodiment, the infrared motion sensor U4 detects motion in a region of interest and provides a pulse to an amplifier U3. A light-sensitive disable switch CDS2 disables the motion detect function when incident light is above a certain threshold, such as during daylight hours. According to this embodiment, the amplifier U3 generates an active logic level at pin 3 for three minutes, in order to control other devices in the main lighting unit after motion has been detected in the region of interest.

A timer U1, shown in FIG. 13, generates a 150 KHz carrier. This carrier is generated under the control of the amplifier U3, so that the carrier is only present during the operational window following detection of motion by the sensor U4. The portion of the circuit including the transistor Q3 and the transformers T1 and T2, along with the supporting components, filters and amplifies the carrier before it is coupled onto the AC line at AC110A and AC110B. Power received over the AC line is processed by a rectifier formed by the diodes D2-D5, the resistor R25, and the capacitor C29, and is then provided to the timer U1 and an optical switch U2 to power operation of the unit.

A triac DS2 controls illumination of the lamp. Depending on the position of the switch S1, the triac DS2 is controlled by either the motion sensor U4 via the amplifier U3, or by a second light-sensitive disable switch CDS1. Thus, the lamp can be prevented from illuminating during daytime hours by use of the switch S1.

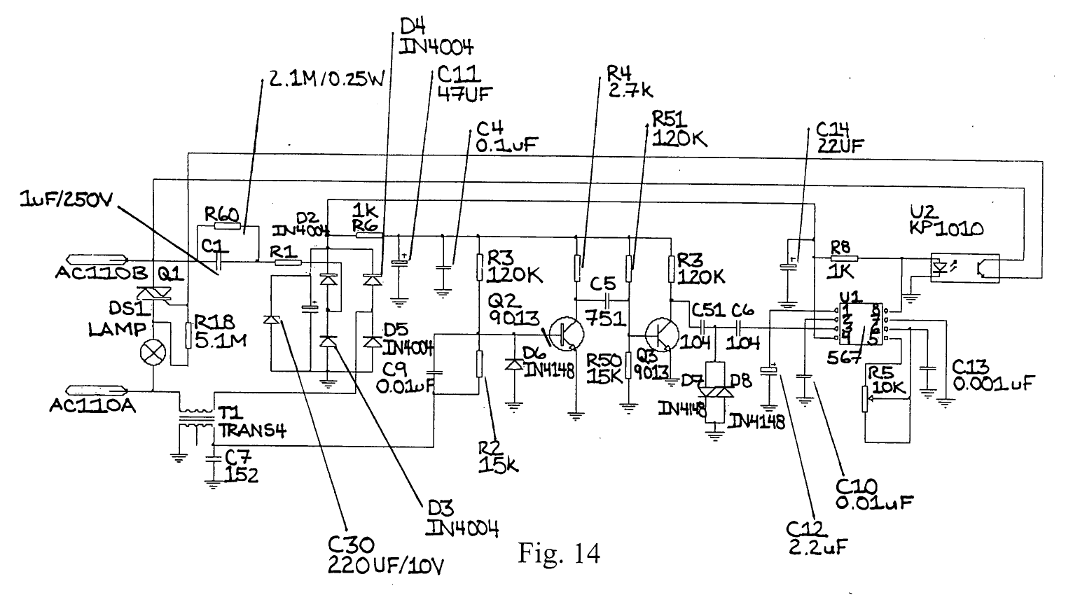

FIG. 14 is a schematic diagram of an exemplary circuit that provides the functionality of the remote lighting unit. As shown, terminals AC110A, B are adapted to receive AC power, and also receive the carrier signal transmitted by the main lighting unit. In the exemplary embodiment shown, the signal is received and filtered, and then amplified at Q2 and Q3. The amplified signal is provided to a tone detector U1, which generates a positive logic signal to actuate an optical coupler U2 when the signal from the transmitter is detected. On actuation, the optical coupler U2 allows the triac DS1 to provide power to illuminate the lamp.

It is contemplated that any number of remote lighting units can be included with the lighting assembly of the present invention, and that mixed quantities of parallel and serially configured remote lighting units can be used. It is also contemplated that certain embodiments of the units can be completely DC powered, allowing the units to be free-standing, or attached to a wall or other surface, independent of the location of AC outlets.

Particular exemplary embodiments of the present invention have been described in detail. These exemplary embodiments are illustrative of the inventive concept recited in the appended claims, and are not limiting of the scope or spirit of the present invention as contemplated by the inventors.

What is claimed is:

1. A lighting assembly, comprising:
a main lighting unit, including a stimulus detector and a transmitter; and
a remote lighting unit, including a receiver unit and a remote light socket;
wherein the main lighting unit responds to detection of a predetermined stimulus by the stimulus detector to cause the transmitter to transmit an actuation signal; and
wherein the receiver unit receives the actuation signal and in response changes an actuation state of the remote light socket from a first actuation state to a second actuation state.

2. The lighting assembly of claim 1, wherein the receiver unit includes a receiver that receives the actuation signal and a controller that changes the actuation state of the remote light socket in response to receipt of the actuation signal.

3. The lighting assembly of claim 1, wherein the remote lighting unit includes a light element in communication with the remote light socket such that the light element is illuminated when the actuation state of the remote light socket is changed from the first actuation state to the second actuation state.

4. The lighting assembly of claim 3, wherein the light element is a light bulb.

5. The lighting assembly of claim 3, wherein the light element is a light emitting diode.

6. The lighting assembly of claim 1, wherein the remote lighting unit includes a light element in communication with the remote light socket such that the light element is illuminated at a first brightness level when the remote light socket is in the first actuation state, and the light element is illuminated at a second brightness level when the remote light socket is in the second actuation state.

7. The lighting assembly of claim 6, wherein the second brightness level is greater than the first brightness level.

8. The lighting assembly of claim 1, wherein the remote lighting unit includes a plurality of remote light sockets.

9. The lighting assembly of claim 8, wherein the number of the plurality of the remote light sockets that is actuated changes from a first number of actuated remote light sockets to a second number of actuated remote light sockets in response to detection of the predetermined stimulus by the stimulus detector.

10. The lighting assembly of claim 9, wherein the second number of actuated remote light sockets is greater than the first number of the plurality of actuated remote light sockets.

11. The lighting assembly of claim 1, wherein the main lighting unit further includes a main light socket.

12. The lighting assembly of claim 11, wherein an actuation state of the main light socket is changed from a first actuation state to a second actuation state in response to detection of the predetermined stimulus by the stimulus detector.

13. The lighting assembly of claim 12, wherein the main lighting unit further includes a light element in communication with the main light socket such that the light element is illuminated when the actuation state of the main light socket is changed from a first actuation state to a second actuation state.

14. The lighting assembly of claim 13, wherein the light element is a light bulb.

15. The lighting assembly of claim 13, wherein the light element is a light emitting diode.

16. The lighting assembly of claim 12, wherein the main lighting unit includes a light element in communication with the main light socket such that the light element is illuminated at a first brightness level when the main light socket is in the first actuation state, and the light element is illuminated at a second brightness level when the main light socket is in the second actuation state.

17. The lighting assembly of claim 16, wherein the second brightness level is greater than the first brightness level.

18. The lighting assembly of claim 1, wherein the main lighting unit further includes a plurality of main light sockets.

19. The lighting assembly of claim 18, wherein the number of the plurality of the main light sockets that is actuated changes from a first number of actuated main light sockets to a second number of actuated main light sockets in response to detection of the predetermined stimulus by the stimulus detector.

20. The lighting assembly of claim 19, wherein the second number of actuated main light sockets is greater than the first number of the plurality of actuated main light sockets.

21. The lighting assembly of claim 1, wherein the stimulus detector is a motion detector.

22. The lighting assembly of claim 21, wherein the motion detector is a heat-sensing motion detector.

23. The lighting assembly of claim 21, wherein the motion detector is a light-sensing motion detector.

24. The lighting assembly of claim 21, wherein the motion detector is a pressure-sensing motion detector.

25. The lighting assembly of claim 24, wherein the pressure-sensing motion detector senses a change in sound level.

26. The lighting assembly of claim 1, wherein the transmitter is an RF transmitter and the receiver unit includes an RF receiver.

27. The lighting assembly of claim 1, wherein the main lighting unit and the remote lighting unit include respective couplers that are adapted to couple the transmitter and the receiver unit for communication over an electrically-conductive path.

28. The lighting assembly of claim 27, wherein the respective couplers are adapted to couple the transmitter and the receiver unit for communication over AC house wiring.

29. The lighting assembly of claim 27, wherein the respective couplers are adapted to couple the transmitter and the receiver unit for communication over a cable.

30. The lighting assembly of claim 29, wherein the respective couplers are adapted to couple the transmitter and the receiver unit for communication over fiber-optic cable.

31. The lighting assembly of claim 27, wherein the transmitter is adapted to transmit the actuation signal over the electrically-conductive path, and the receiver unit is adapted to receive the actuation signal over the electrically-conductive path.

32. The lighting assembly of claim 1, further comprising a timer that initiates a count when the stimulus detector detects the predetermined stimulus.

33. The lighting assembly of claim 32, further comprising a controller that returns the actuation state of the remote light socket from the second actuation state to the first actuation state when the count reaches a predetermined value.

34. The lighting assembly of claim 1, further comprising a timer that initiates a count when the receiver unit receives the actuation signal.

35. The lighting assembly of claim 1, wherein the remote lighting unit is a first remote lighting unit including a first receiver unit and a first remote light socket, and
further comprising a second remote lighting unit including a second receiver unit and a second remote light socket,
wherein the second receiver unit receives the actuation signal and in response changes an actuation state of the second remote light socket from a first actuation state to a second actuation state.

36. The lighting assembly of claim 1, wherein the remote lighting unit is a first remote lighting unit including a first receiver unit that receives a first actuation signal, and a first remote light socket, and
further comprising a second remote lighting unit including a second receiver unit and a second remote light socket,
wherein the first remote lighting unit further includes a second transmitter that transmits a second actuation signal in response to receipt of the first actuation signal by the first receiver unit, and
wherein the second receiver unit receives the second actuation signal and in response changes an actuation state of the second remote light socket from a first actuation state to a second actuation state.
